(19) United States
(12) Patent Application Publication
(10) Pub. No.: US 2023/0402873 A1
(43) Pub. Date: Dec. 14, 2023

(54) ELECTRONIC DEVICE CHARGING DEVICE

(71) Applicant: Tracy O'Brien Swain, Elizabeth City, NC (US)

(72) Inventor: Tracy O'Brien Swain, Elizabeth City, NC (US)

(21) Appl. No.: 17/840,365

(22) Filed: Jun. 14, 2022

(51) Int. Cl. H02J 50/10; H02J 7/00; H04B 1/04

(52) U.S. Cl. CPC H02J 50/10; H02J 7/0049; H04B 1/04

(57) ABSTRACT

An electronic device charging device connected to at least one external device, the electronic device charging device including a main body, a communication unit disposed on at least a portion of the main body, and a processing unit disposed within at least a portion of the main body to monitor a power level of the at least one external device, such that the communication unit automatically charges the at least one external device in response to the power level of the at least one external device falling below a predetermined power level of the at least one external device.

### BACKGROUND

### 1. Field

The present general inventive concept relates generally to charging, and particularly, to an electronic device charging device.

### 2. Description of the Related Art

Many mobile devices, such as cell phones, laptop computers, and/or tablet computers, rely on battery power to operate. The mobile devices must be connected to an external power source to charge the battery to ensure continued operation.

Mobile devices are often charged by connecting a cord to a power outlet. Some mobile devices are disposed on a wireless charger (e.g., a charging pad) that is capable of charging the mobile device while the mobile device remains on the wireless charger. Regardless of the type of charger used, the mobile device depends on a user to determine when the mobile device needs charging and to physically move the mobile device to enable charging.

Therefore, there is a need for an electronic device charging device that charges the mobile device without requiring interaction by the user.

### SUMMARY

The present general inventive concept provides an electronic device charging device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an electronic device charging device connected to at least one external device, the electronic device charging device including a main body, a communication unit disposed on at least a portion of the main body, and a processing unit disposed within at least a portion of the main body to monitor a power level of the at least one external device, such that the communication unit automatically charges the at least one external device in response to the power level of the at least one external device falling below a predetermined power level of the at least one external device.

The communication unit may generate and transmit an oscillating magnetic field therefrom to charge the at least one external device.

The communication unit may use a magnetic loop to charge the at least one external device.

The processing unit may suspend charging in response to detecting the at least one external device has reached a full charge.

The processing unit may suspend charging in response to the at least one external device has already reached a full charge having charged from less than eighty percent, and a current charge level remains above eighty percent.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front perspective view of an electronic device charging device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Electronic Device Charging Device 100
Main Body 110
Communication Unit 120
Processing Unit 130
Power Button 140
Power Source 150
Legs 160

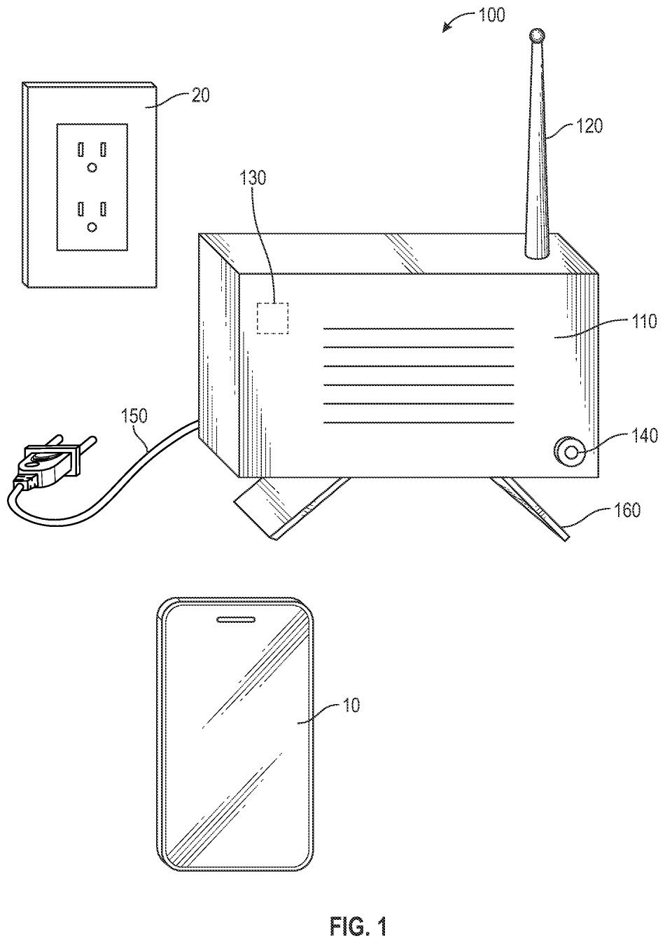

FIG. 1 illustrates a front perspective view of an electronic device charging device 100, according to an exemplary embodiment of the present general inventive concept.

The electronic device charging device 100 may be constructed from at least one of metal, plastic, wood, and rubber, etc., but is not limited thereto.

The electronic device charging device 100 may include a main body 110, a communication unit 120, a processing unit 130, a power button 140, a power source 150, and a plurality of legs 160, but is not limited thereto.

Referring to FIG. 1, the main body 110 is illustrated to have a rectangular prism shape. However, the main body 110 may be rectangular, circular, cylindrical, triangular, pentagonal, hexagonal, heptagonal, octagonal, or any other shape known to one of ordinary skill in the art, but is not limited thereto.

The main body 110 may be removably disposed on at least a portion of a surface (e.g., a table, a countertop, a desk).

Referring again to FIG. 1, the communication unit 120 is illustrated to be an antenna. However, the communication unit 120 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

Furthermore, the communication unit 120 may further include copper coils that emit an electromagnetic field, electromagnetic induction, non-radiative charging, uncoupled RF, electromagnetic resonance, and a magnetic loop, but is not limited thereto.

The communication unit 120 may be disposed on and/or within at least a portion of the main body 110. The communication unit 120 may generate and/or transmit an oscillating magnetic field and/or an electromagnetic field therefrom. Also, the communication unit 120 may connect to at least one external device 10.

The processing unit 130 (or central processing unit, CPU) may include electronic circuitry to carry out instructions of a computer program by performing basic arithmetic, logical, control and input/output (I/O) operations specified by the instructions. The processing unit 130 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 130 may also include a microprocessor and a microcontroller.

The processing unit 130 may be disposed within at least a portion of the main body 110. The processing unit 130 may have a program and/or a software application running thereon. Hereafter, the program and/or the software application may be referred to as an app. The processing unit 130 executing the app may monitor a power level (e.g., a battery level) of the at least one external device 10 (e.g., a mobile device, a cell phone, a tablet computer, a laptop computer, a personal digital assistant (PDA), and/or any other type of battery powered device). Moreover, the at least one external device 10 may also have the app installed thereon to facilitate communication with the processing unit 130. However, the processing unit 130 executing the app may scan for a presence of the at least one external device 10 based on the power level determined to be based on a battery. In other words, the processing unit 130 may not require the app to monitor the power level of the at least one external device 10. Also, the processing unit 130 may monitor for the presence of the at least one external device 10 based on a predetermined range from the communication unit 120, such as five feet, ten feet, twenty feet, thirty feet, etc.). As such, the at least one external device 10 may remain disposed a distance away from the communication unit 120 and still be charged.

Furthermore, the processing unit 130 executing the app may send a charge command to the communication unit 120 in response to the power level of the at least one external device 10 falling below a predetermined power level of the at least one external device 10 (e.g., one percent, five percent, ten percent, etc.). As such, the communication unit 120 may automatically generate and/or transmit the oscillating magnetic field and/or the electromagnetic field to the at least one external device 10 to charge the at least one external device 10. Accordingly, the communication unit 120 and/or the processing unit 130 may automatically charge the at least one external device 10 as needed without intervention by a user.

The processing unit 130 executing the app may suspend charging in response to detecting the at least one external device 10 has reached a full charge (i.e., 100%) and/or after the at least one external device 10 has reached the full charge having charged from less than eighty percent, and a current charge level remains above eighty percent.

The power button 140 may be disposed on at least a portion of the main body 110. The communication unit 120 and/or the processing unit 130 may turn on in response to depressing the power button 140 a first time. Subsequently, the communication unit 120 and/or the processing unit 130 may turn off in response to depressing the power button 140 a second time.

The power source 150 may include a power inlet and a solar cell, but is not limited thereto.

The power source 150 may be disposed on at least a portion of the main body 110 and/or connected to a power outlet 20. The power source 150 may provide power to the communication unit 120, the processing unit 130, and/or the power button 140.

The plurality of legs 160 may be disposed on at least a portion of the main body 110. The plurality of legs 160 may support the main body 110 thereon. Moreover, the main body 110 may be disposed away from the surface equivalent to a length of the plurality of legs 160.

Therefore, the electronic device charging device 100 may charge the at least one external device 10 without requiring action by the user. Also, the electronic device charging device 100 may reduce space during charging due to a lack of requirement for a cord.

The present general inventive concept may include an electronic device charging device 100 connected to at least one external device 10, the electronic device charging device 100 including a main body 110, a communication unit 120 disposed on at least a portion of the main body 110, and a processing unit 130 disposed within at least a portion of the main body 110 to monitor a power level of the at least one external device 10, such that the communication unit 120 automatically charges the at least one external device 10 in response to the power level of the at least one external device 10 falling below a predetermined power level of the at least one external device 10.

The communication unit 120 may generate and transmit an oscillating magnetic field therefrom to charge the at least one external device 10.

The communication unit 120 may use a magnetic loop to charge the at least one external device 10.

The processing unit 130 may suspend charging in response to detecting the at least one external device has reached a full charge.

The processing unit 130 may suspend charging in response to the at least one external device 10 has already reached a full charge having charged from less than eighty percent, and a current charge level remains above eighty percent.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An electronic device charging device connected to at least one external device, the electronic device charging device comprising:
a main body;
a communication unit disposed on at least a portion of the main body; and
a processing unit disposed within at least a portion of the main body to monitor a power level of the at least one external device, such that the communication unit automatically charges the at least one external device in response to the power level of the at least one external device falling below a predetermined power level of the at least one external device.

2. The electronic device charging device of claim 1, wherein the communication unit generates and transmits an oscillating magnetic field therefrom to charge the at least one external device.

3. The electronic device charging device of claim 1, wherein the communication unit uses a magnetic loop to charge the at least one external device.

4. The electronic device charging device of claim 1, wherein the processing unit suspends charging in response to detecting the at least one external device has reached a full charge.

5. The electronic device charging device of claim 1, wherein the processing unit suspends charging in response to the at least one external device has already reached a full charge having charged from less than eighty percent, and a current charge level remains above eighty percent.
